(19) United States
(12) Patent Application Publication
(10) Pub. No.: US 2005/0194399 A1
(43) Pub. Date: Sep. 8, 2005

(54) Beverage serving control system

(75) Inventor: Darren Proctor, Willard, MO (US)

Correspondence Address: Joseph L. Johnson;LATHROP & GAGE, L.C., 1845 S. National, P.O. Box 4288, Springfield, MO, 65808-4288, US

(73) Assignee: Tek-Know, LLC

(21) Appl. No.: 11/070,975

(22) Filed: Mar. 3, 2005

Related U.S. Application Data
(60) Provisional application No. 60/550,488, filed on Mar. 3, 2004.

(51) Int. Cl. B67B 7/00; G01F 11/00

(52) U.S. Cl. 222/1

(57) ABSTRACT

A beer dispensing system which measures beer flow by volume and electronically controls a valve to precisely dispense predetermined volumes of beer. To accurately measure liquid to be dispensed, a cellar valve is used to eliminate beer foam from the beer lines. Beer passes through a flow monitor which electronically relays volumetric information to a control panel. A user inputs a preset volume of beer desired and the control valve opens allowing a flow of beer. When the specific volume of beer has passed through the flow monitor, the control panel causes the control valve to close. This reduces waste and allows a user to attribute revenue to specific employees who electronically input information particular to beer dispensed.

### CROSS REFERENCE TO RELATED PROVISIONAL PATENT

This non-provisional application claims priority of the provisional application No. 60/550,488 filed on Mar. 3, 2004.

### FIELD OF THE INVENTION

This invention relates to a control and monitoring system for beverage dispensing containers such as beer kegs. More particularly, the system controls dispensed beer volumes, generates electrical data from a liquid flow meter and, through associated computer software, generates information including flow rate, flow volume, cost of beer and sales value of beer dispensed.

### BACKGROUND OF THE INVENTION

Keg beer sold in restaurants, taverns and bars is big business. Millions of gallons of beer are poured from tapped kegs every year. There are two common problems associated with keg beer sales. First, it is difficult to determine how much beer is wasted compared to the amount of beer actually sold. Second, employee theft of beer or funds generated from the sale of beer is difficult to monitor and control.

A variety of devices and methods have been developed over the years to eliminate waste and theft associated with keg beer sales. Generally, these devices relate to cash register security and access to cash. For example, a restaurant employee may be required to to enter a code into the cash register for each sale so that the owner can attribute sales and money taken in to specific employees. It does not, however, prevent employee theft and waste.

Generally, monitoring systems directed to cash register security and cash receivables are easy for employees to cheat. For example, a restaurant employee serving 12 ounce beers can simply serve twelve 11 ounce beers and generate one “free” beer every twelfth serving. Unfortunately there has not been a good method for tracking the volume of beer sold because of variances in serving sizes and due to waste created by excessive foaming.

While several products have been developed directed to the volumetric mixing and dispensing of soft drinks, there are no known systems or devices adaptable to or for specific use on beer keg systems. Applicant's invention overcomes these problems.

### SUMMARY OF THE INVENTION

The present invention provides a novel system for accurately dispensing beer by volume which facilitates monitoring of revenue generated and realized from keg beer sales. More particularly, the invention monitors beer being dispensed by passing it through a flow monitor to precisely measure its volume and then by electronically causing a control valve to open and shut to dispense the desired volume of beer.

A cellar valve is used to eliminate beer foaming so that a consistent and precise measurement of beer can be dispensed. This also eliminates the waste usually associated with over-pouring resulting from beer foaming from to air in the dispensing lines. The entire dispensing process is controlled by an electronic control card which receives user directions, such as the volume of beer to be dispensed. The control card then causes the control valve to open to commence dispensing the beer. As beer is dispensed, flow volume information is relayed to the control card from the flow monitor and after a predetermined volume of beer passes through the flow monitor, the control card electronically signals the control valve to close.

This system is connected to simple computerized inventory control software that tracks the volume of beer dispensed by numerous users. Accordingly, beer sales can be tracked by time, volume, employee dispensing beer, revenue attributed to each beer sale and other general inventory control and accounting information. The system helps a business owner determine whether employees are taking in money for beer or attempting to take without paying. Further, because each beer pour is controlled by volume in response to input from the user, wasted beer is eliminated.

### DRAWINGS

FIG. 1 shows a schematic configuration of one embodiment of the inventive system

### DETAILED DESCRIPTION

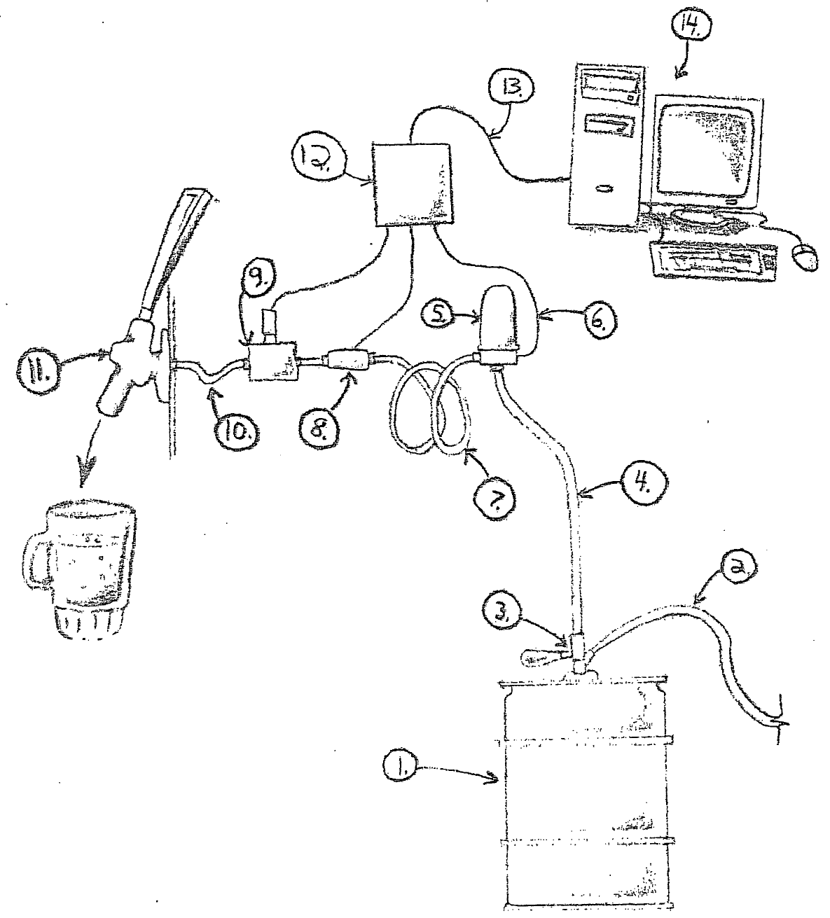

Referring now generally to FIG. 1, the beer dispensing and monitoring system of the present invention comprises a mechanical dispensing assembly operatively connected to an electronic monitoring center. The system incorporates commercially available computer software to analyze and track fluid data generated from the electronic component of this system.

The mechanical portion of the invention includes a beer line attached to a beer keg or similar dispensing container by traditional means such as beer keg tap. This application is generally designed for commercial applications which would include a remote pressurization device such as a carbon dioxide (CO2), or compressed air tank connected through a traditional beer keg adjacent the beer keg tap. The remote pressure system forces beer from the keg into the beer line with volumetric dispensing controlled by a simple open and shut lever. The beer line from the keg is attached to a foam detector, a variety of which are commercially available. The foam detector eliminates foam and air from being introduced into the beer lines as the keg is emptied and disconnected for changing. As the fluid level drops in the foam detector due to decrease in available beer, an internal float also drops. When the float reaches a predetermined level, electrical connectors on the float contact electrical receivers which signal a control board that the beer keg is empty and needs to be changed out.

Beer flows from a cellar valve through a second line to a flow sensor. The second line prevents erroneous readings or damage to the flow sensor which could be caused by foam or air passing through the flow sensor. The flow sensor monitors beer flow passing through the lines from which volume can be determined. It is preferred that the flow sensor is approximately the same diameter as the beer line and has both a mechanical and electrical component. One such flow sensor available is manufactured by Digiflow Systems of Mansfield, Ohio (Digiflow Model No. DFS-3W).

As beer flows through the flow sensor, it first passes a fixed worm which creates a spiral liquid flow which then in turns spins a rotor mounted on a low friction bearing. As the rotor turns, the rotor blades interrupt an infrared beam which generates a square wave digital output signal. Flow is determined by electronically counting the number of rotor blade rotations over a given period of time. This information is then passed electronically to the electrical component of this beer monitoring system.

Beer passes from the flow sensor through a third line into an electric control valve. The in line control valve simply regulates the amount of beer passing through the line to a standard tavern head by selectively opening and closing the valve. One such valve which is commercially available is the 2/2 Various beer valve manufactured by Jaksa, in Slovenia, Europe. However, it is preferred that the control valve is constructed with an internal laminar flow plunger to diminish fluid turbulence common in carbonated liquids. This type of valve is not generally available in the marketplace and may have to be constructed. It is also preferable that the control valve is connected to the tavern head with a separate beer hose. A predetermined volume of beer is allowed to pass through the control valve to be dispensed through the standard tavern head.

The electrical portion of the beer dispensing system includes an electrical control panel provided with at least one transformer to step down line voltage to the operable voltage level of the control board and control valve. The control panel is electrically connected to the cellar valve, the flow sensor and the control valve. The control panel is also electrically connected to a computer which is used to regulate and control dispensing each discreet serving and to collect and process information from the mechanical portion of the beer system.

It is preferable that the computer connected to the dispensing system includes a user input system, such as conventional keyboard, mouse, touch screen or similar input. Upon a input, the computer initiates a command, which includes a predetermined volumetric amount to be dispensed, to the control board. The control board electronically signals a specific circuit which causes the control valve to open to allow the specific volume of beer to be dispensed. A variety of information is electronically retrieved from the mechanical portion of the beer monitoring system. This includes information from the foam detector, the flow sensor and the control valve as described herein.

Computer software configured with predetermined volumetric dispensing codes allows the user to input the volume of beer to be dispensed. For example, the computer software may include dispensing codes for 12 ounces, 16 ounces, 24 ounces and 48 ounces. These volumetric dispensing amounts may be tied to generic sale terms such as “small glass”, “large glass” or “pitcher”. The user inputs into the computer the volumetric amount desired to be dispensed from a specific tavern head. The computer relays information particular to the user's decision to a control card which, in turn, controls the control valve causing it to selectively open and close to dispense the desired amount from the specified tavern head. Once the control valve is opened, the volume of beer being dispensed is ascertained from flow passing through the flow sensor. The control card ascertains the volume of beer passing through the flow sensor. Once the desired amount has passed through the flow sensor and control valve, the control card directs the control valve to close. The traditional beer tap or tavern head can be associated with the control valve so that the beer is dispensed through the control valve only when the mechanical tap is open. The beer volume dispensed, however, is determined by the control valve so that a user can open the mechanical tap and know that the beer will not overflow the container, assuming the container selected is appropriate for the volume selected.

The foam detector includes a simple on/off reed switch which is maintained in an “open” position (prevents the passage of electrical current) when beer is available from the beer source. The reed switch closes (allows passage of electrical current) when no beer is passing through the foam detector. This on/off reed switch is electronically connected to the control card to produce a signal or notification of when the beer supply is empty; this signal is relayed to the computer which displays an indicator for the operator.

The data which is electronically retrieved from the mechanical system is then processed through computer software which is configured to calculate liquid volume, liquid flow as well as costs and profits based on predetermined volume pricing.

For example, a standard United States beer keg holds 15.5 gallons or 1,984 ounces. A standard serving size may be determined to be a 12 ounce glass at $2.00 per glass, or 16.7 cents per ounce. As beer passes through the flow sensor, the number of ounces being dispensed is conveyed to the computer software. Software calculates pricing based from the ounces dispensed at a predetermined price. The system does not recalibrate pricing from volume but rather ensures accurate volumetric dispensing. In other words, the $2.00 glass of beer will always be a $2.00 glass of beer because the computer only allows the control valve to dispense the specific volume of beer for the predetermined price. Because each beer tap will only dispense a single type of beer, there is no differentiation between beer types passing through a single flow sensor. Each computer can receive input from, and control, at least eight (8) dispensing systems. The computer includes a twenty four hour, seven day a week clock, which allows the user to track and use time related pricing, such as happy hour or weekend sale prices.

In a second embodiment of the invention, the beer dispensing system will include a device for receiving payment directly from a consumer. The computer will be associated with a cash receiving device and a credit/debit card reader so that a user can input money to directly pay for beer to be dispensed. This feature allows the beer dispensing system to be used by patrons or customers without constant interaction by an owner or employee.

It will be apparent to those skilled in the art that various modifications and variations of the invention may be constructed without departing from the spirit or scope of the invention. The present invention covers all such modifications and variations of this invention which is further described and defined within the appended claims and their equivalents.

1. A beer dispensing system comprising a beer source for supplying beer to a beer outlet, wherein beer passes from the beer source through a flow sensor which measures liquid volume and a control valve which is selectively opened and closed during a single operation to dispense a predetermined volume of beer; the system further having an electronic control card that receives volumetric data from the flow sensor and electronically signals the control valve to open and then close after a predetermined volume of beer has passed through the flow sensor such that a predetermined volume of beer is dispensed through the beer outlet.

2. The beer dispensing system of claim 1, further comprising an computer input device which allows a user to input predetermined volumetric dispensing information which electronically signals the control card to cause the control valve to open and then close to dispense a desired volume of beer.

3. The beer dispensing system of claim 1, further comprising a foam detector between the beer source and the flow sensor to limit foaming and air intrusion into beer lines, and to electronically notify a user of cessation of beer flow.

4. The beer dispensing system of claim 1, further comprising a computer for sending and receiving information related to the volumetric flow of beer to the control card, and to electronically record and assimilate information particular to the historic dispensing of beer through the device.

5. A beer dispensing system comprising a beer source for supplying beer to a beer outlet, wherein beer passes through a flow sensor which calculates liquid volume and a control valve which opens and closes to allow a predetermined volume of beer to pass therethrough during a single operation; a control card connected to a computer, the flow sensor and control valve, and wherein the computer is configured to recognize flow volume information electronically received from the flow sensor and to electronically signal the control valve to selectively open and close after the passage of the predetermined volume of beer.

6. A beer dispensing system for regulating, monitoring and controlling keg beer sales, comprising: a beer supply connected to a flow sensor which measures flow rate and volume; a control valve in fluid communication with the flow sensor and a beer outlet; and an electronic control board connected to the flow sensor for receiving volume and flow data and connected to the control valve for electronically instructing the valve to selectively open to dispense beer and close after passage of a predetermined volume of beer.

7. The beer dispensing system of claim 6, further comprising a cellar valve for controlling foam positioned between the beer supply and the flow sensor, the cellar valve connected to the electronic control board and further configured to electronically signal the absence of beer flow.

8. A beer dispensing system comprising an electronic control card in electronic communication with a flow sensor which measures liquid volume and a control valve through which beer is selectively allowed to pass, wherein the control card signals the control valve to open to allow beer to be dispensed at the direction of a user and after a predetermined volume of beer passes through the flow sensor it returns a signal to the control card which in turn signals the control valve to shut and discontinue the flow of beer.
